(19) United States
(12) Patent Application Publication
(10) Pub. No.: US 2025/0321863 A1
(43) Pub. Date: Oct. 16, 2025

(54) SERVER SYSTEM

(71) Applicant: MITAC COMPUTING TECHNOLOGY CORPORATION, Taoyuan City (TW)

(72) Inventor: Ya-Wen SHIH, Taoyuan City (TW)

(73) Assignee: MITAC COMPUTING TECHNOLOGY CORPORATION, Taoyuan City (TW)

(21) Appl. No.: 18/891,025

(22) Filed: Sep. 20, 2024

(30) Foreign Application Priority Data
Apr. 12, 2024 (TW) 113113881

(51) Int. Cl. G06F 11/36

(52) U.S. Cl. CPC G06F 11/3656

(57) ABSTRACT

A server system includes a first control circuit and a second control circuit. The first control circuit includes a first controller, a second controller, a first input/output circuit, and a second input/output circuit. The first input/output circuit is coupled to the first controller. The second input/output circuit is coupled to the second controller and the first input/output circuit. The second controller is configured to transmit a debug log of the first control circuit to the second input/output circuit. The second input/output circuit is configured to transmit the debug log of the first control circuit to the first input/output circuit. The second control circuit is coupled between the first input/output circuit and the second input/output circuit. The second control circuit is configured to selectively control data to be transmitted from the first input/output circuit to the second input/output circuit.

### CROSS-REFERENCE TO RELATED APPLICATION

This non-provisional application claims priority under 35 U.S.C. § 119(a) to Patent Application No. 113113881 filed in Taiwan, R.O.C. on Apr. 12, 2024, the entire contents of which are hereby incorporated by reference.

### BACKGROUND

### Technical Field

The present invention relates to server debugging, in particular relates to a server system that allows immediate viewing of debug messages from the BMC (Baseboard Management Controller) through a remote screen and prevents malicious tampering with the BMC.

### Related Art

Generally, during the development process of a server, the internal hardware of the server is designed with a BMC debug interface (such as pins or USB ports). The development engineers of the BMC in the server can connect a cable to the BMC debug interface to obtain debug messages of the BMC, facilitating subsequent functionality development and debugging by the engineers.

However, when the server enters the mass production stage, since the relevant functions of the BMC have already been developed, the BMC debug interface is usually removed or covered by the outer casing of the server to save costs or ensure the security of the server. This makes it difficult for BMC development engineers to quickly and effectively identify and solve problems when issues occur with the server in the future.

### SUMMARY

In some embodiments, a server system comprises a first control circuit and a second control circuit. The first control circuit comprises a first controller, a second controller, a first input/output circuit, and a second input/output circuit. The first input/output circuit is coupled to the first controller. The second input/output circuit is coupled to the second controller and the first input/output circuit. The second controller is configured to transmit a debug log of the first control circuit to the second input/output circuit. The second input/output circuit is configured to transmit the debug log of the first control circuit to the first input/output circuit. The second control circuit is coupled between the first input/output circuit and the second input/output circuit. The second control circuit is configured to selectively control data to be transmitted from the first input/output circuit to the second input/output circuit.

In some embodiments, the server system further comprises a circuit board. The circuit board has a development stage board number value. The first control circuit and the second control circuit are disposed on the circuit board. The second control circuit further comprises a second storage unit. The second storage unit is configured to store an authorization value. The second control circuit is configured to execute a control procedure according to the development stage board number value and the authorization value to control the data to be transmitted from the first input/output circuit to the second input/output circuit.

In some embodiments, the development stage board number value is one of a zero stage value, a first stage value, or a second stage value. The authorization value is one of a zero authorization value, a first authorization value, or a second authorization value. The second stage value is greater than the first stage value and the first stage value is greater than the zero stage value. The second authorization value is greater than the first authorization value and the first authorization value is greater than the zero authorization value. The value of the zero stage value is equal to the value of the zero authorization value. The value of the first stage value is equal to the value of the first authorization value. The value of the second stage value is equal to the value of the second authorization value. The control procedure comprises: reading the authorization value and the development stage board number value; comparing the value of the authorization value and the value of the development stage board number value; when the authorization value is greater than or equal to the development stage board number value, determining whether the development stage board number value is the zero stage value and whether the authorization value is the zero authorization value; when the development stage board number value is the zero stage value and the authorization value is the zero authorization value, setting the authorization value to the second authorization value; determining whether the authorization value is the second authorization value or the first authorization value; and when the authorization value is the second authorization value, determining that the data cannot be transmitted from the first input/output circuit to the second input/output circuit.

In some embodiments, the control procedure further comprises: when the authorization value is less than the development stage board number value, setting the value of the authorization value to be equal to the value of the development stage board number value.

In some embodiments, the control procedure further comprises: when the authorization value is the first authorization value, determining whether the development stage board number value is the second stage value; when the development stage board number value is the second stage value, determining that the data cannot be transmitted from the first input/output circuit to the second input/output circuit; and when the development stage board number value is not the second stage value, determining that the data can be transmitted from the first input/output circuit to the second input/output circuit.

In some embodiments, the second control circuit further comprises a switch circuit. The switch circuit is coupled to the second input/output circuit and the first input/output circuit. The control procedure further comprises: when determining that the data cannot be transmitted from the first input/output circuit to the second input/output circuit, turning off the switch circuit to disconnect the second input/output circuit and the first input/output circuit; and when determining that the data can be transmitted from the first input/output circuit to the second input/output circuit, turning on the switch circuit to connect the second input/output circuit and the first input/output circuit.

In some embodiments, the second input/output circuit is coupled to the first input/output circuit through a receive line and a transmit line. The control procedure further comprises: when determining that the data cannot be transmitted from the first input/output circuit to the second input/output circuit, turning off the switch circuit to disconnect the receive line; and when determining that the data can be transmitted from the first input/output circuit to the second input/output circuit, turning on the switch circuit to connect the receive line.

In some embodiments, the server system further comprises a firmware system. The first control circuit further comprises a third controller, a third input/output circuit, and a firmware input/output circuit. The third input/output circuit is coupled to the third controller. The firmware system is coupled to the third controller through the firmware input/output circuit. The third controller is configured to transmit a debug log of the firmware system to the third input/output circuit.

In some embodiments, the server system further comprises a logic circuit. The logic circuit is disposed on the circuit board. The first control circuit further comprises a fourth controller and a fourth input/output circuit. The fourth input/output circuit is coupled to the fourth controller. The logic circuit is coupled to the fourth controller. The fourth controller is configured to transmit a debug log of the logic circuit to the fourth input/output circuit.

In some embodiments, the first controller, the third controller, and the fourth controller support SOL (Serial Over LAN).

In some embodiments, the first control circuit further comprises a first storage unit. The first storage unit is configured to store an output command. The first control circuit is further coupled to a management device through a communication network. The first control circuit is further configured to transmit one of the debug log of the first control circuit, the debug log of the firmware system, and the debug log of the logic circuit to the management device according to the output command.

The following will describe the detailed features and advantages of the instant disclosure in detail in the detailed description. The content of the description is sufficient for any person skilled in the art to comprehend the technical context of the instant disclosure and to implement it accordingly. According to the content, claims and drawings disclosed in the instant specification, any person skilled in the art can readily understand the goals and advantages of the instant disclosure.

### BRIEF DESCRIPTION OF THE DRAWINGS

The disclosure will become more fully understood from the detailed description given herein below for illustration only, and thus not limitative of the disclosure, wherein:

FIG. 1 illustrates a block schematic diagram of an embodiment of a server system.

FIG. 2 illustrates a flowchart of an embodiment of a control procedure.

### DETAILED DESCRIPTION

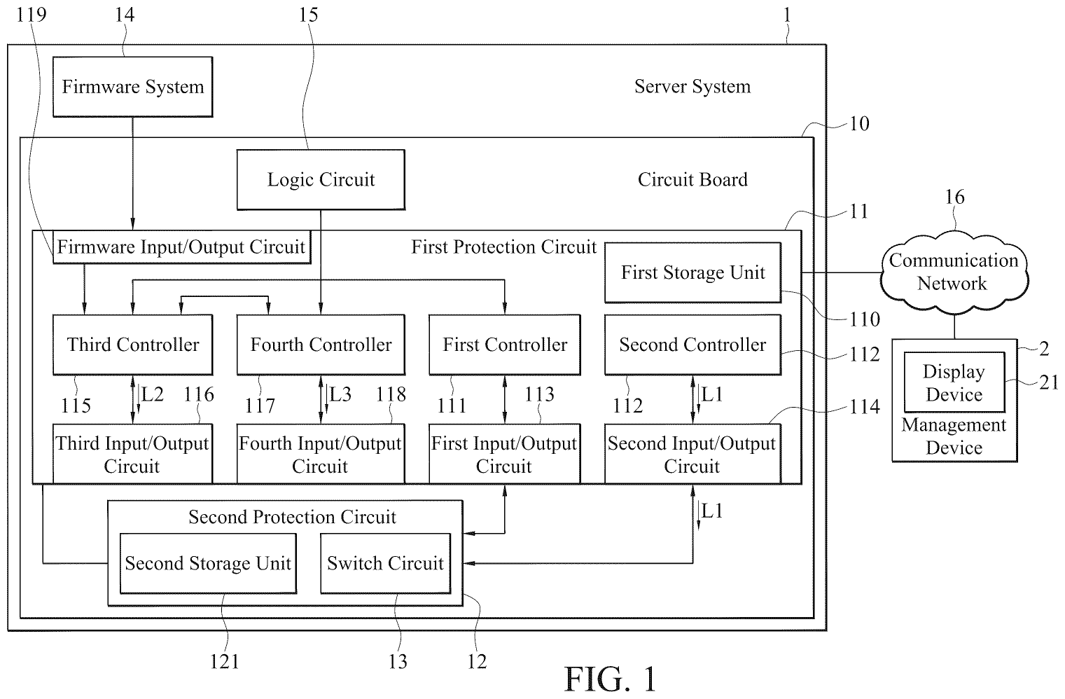

Please refer to FIG. 1. A server system 1 comprises a first control circuit 11 and a second control circuit 12. The first control circuit 11 comprises a first controller 111, a second controller 112, a first input/output circuit 113, and a second input/output circuit 114. The first input/output circuit 113 is coupled to the first controller 111. The second input/output circuit 114 is coupled to the second controller 112 and the first input/output circuit 113. The second controller 112 is configured to transmit a debug log L1 of the first control circuit 11 to the second input/output circuit 114. The second input/output circuit 114 is configured to transmit the debug log L1 of the first control circuit 11 to the first input/output circuit 113. The second control circuit is coupled between the first input/output circuit 113 and the second input/output circuit 114. The second control circuit 12 is configured to selectively control data to be transmitted from the first input/output circuit 113 to the second input/output circuit 114. In some embodiments, the first control circuit 11 may be but not limited to a Baseboard Management Controller (BMC). In some embodiments, the second control circuit 12 may be but not limited to a Complex Programmable Logic Device (CPLD).

In some embodiments, the server system 1 further comprises a circuit board 10. The first control circuit 11 and the second control circuit 12 are disposed on the circuit board 10, but the present invention is not limited thereto. The second control circuit 12 may be disposed on another circuit board (not shown in the FIGs). In some embodiments, the second control circuit 12 further comprises a second storage unit 121. The second storage unit 121 is configured to store an authorization value. In some embodiments, the circuit board 10 has a development stage board number value. The second control circuit 12 executes a control procedure P1 according to the development stage board number value and the authorization value to control the data to be transmitted from the first input/output circuit 113 to the second input/output circuit 114. In some embodiments, the second storage unit 121 may be volatile storage media, non-volatile storage media, or a combination thereof. Volatile storage media include, for example, Random Access Memory (RAM), such as Static Random Access Memory (SRAM) or Dynamic Random Access Memory (DRAM). Non-volatile storage media include, for example, Read-Only Memory (ROM), such as Programmable Read-Only Memory (PROM), Erasable Programmable Read-Only Memory (EPROM), Electrically Erasable Programmable Read-Only Memory (EEPROM), One-Time Programmable Read-Only Memory (OTPROM), or Flash Memory. The type of the second storage unit 121 is not limited herein.

In some embodiments, the development stage board number value is one of a zero stage value, a first stage value, or a second stage value. The authorization value is one of a zero authorization value, a first authorization value, or a second authorization value. The second stage value is greater than the first stage value and the first stage value is greater than the zero stage value. The second authorization value is greater than the first authorization value and the first authorization value is greater than the zero authorization value. The value of the zero stage value is equal to the value of the zero authorization value. The value of the first stage value is equal to the value of the first authorization value. The value of the second stage value is equal to the value of the second authorization value.

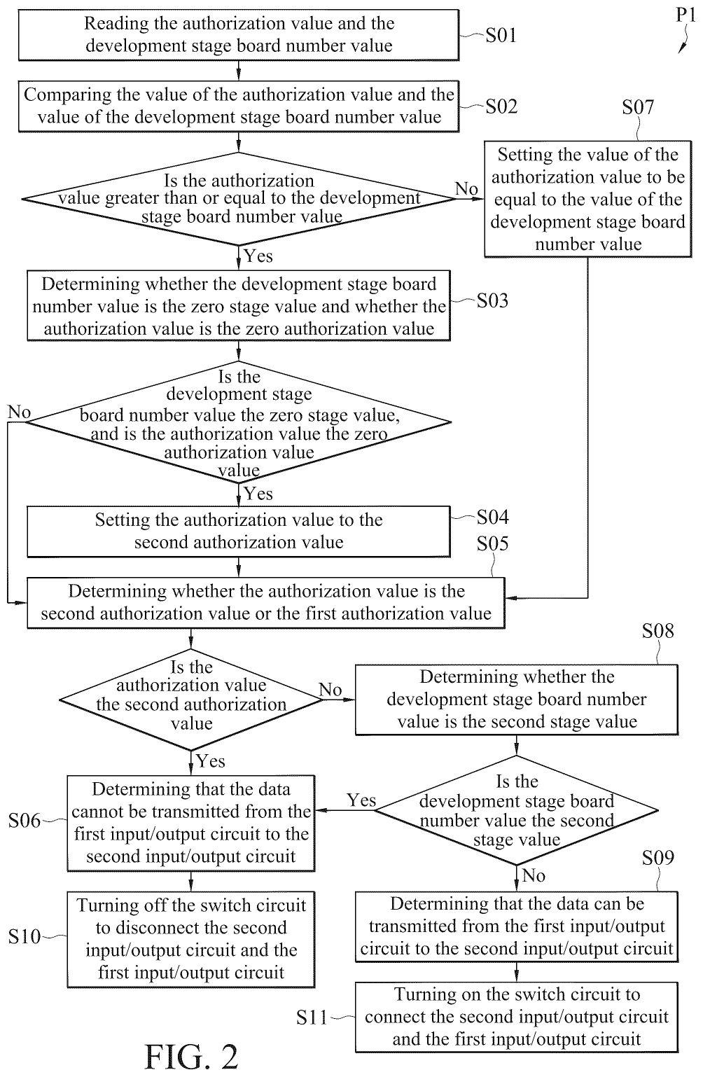

Please refer to FIG. 2. In some embodiments, first, the second control circuit 12 reads the authorization value and the development stage board number value (Step S01). Then, the second control circuit 12 compares the value of the authorization value and the value of the development stage board number value (Step S02). When the authorization value is greater than or equal to the development stage board number value, the second control circuit 12 determines whether the development stage board number value is the zero stage value and whether the authorization value is the zero authorization value (Step S03). When the development stage board number value is the zero stage value and the authorization value is the zero authorization value, the second control circuit 12 sets the authorization value to the second authorization value (Step S04). Next, the second control circuit 12 determines whether the authorization value is the second authorization value or the first authorization value (Step S05). When the authorization value is the second authorization value, the second control circuit 12 determines that the data cannot be transmitted from the first input/output circuit 113 to the second input/output circuit 114 (Step S06).

In some embodiments, when the authorization value is less than the development stage board number value, the second control circuit 12 sets the value of the authorization value to be equal to the value of the development stage board number value (Step S07).

In some embodiments, when the authorization value is the first authorization value, the second control circuit 12 determines whether the development stage board number value is the second stage value (Step S08). When the development stage board number value is the second stage value, the second control circuit 12 determines that the data cannot be transmitted from the first input/output circuit 113 to the second input/output circuit 114 (Step S06). When the development stage board number value is not the second stage value, the second control circuit 12 determines that the data can be transmitted from the first input/output circuit 113 to the second input/output circuit 114 (Step S09).

For example, assume that the zero stage value is 0, the first stage value is 1, the second stage value is 2, the zero authorization value is 0, the first authorization value is 1, and the second authorization value is 2. In this case, the second stage value (i.e., 2) is greater than the first stage value (i.e., 1), the first stage value (i.e., 1) is greater than the zero stage value (i.e., 0), the second authorization value (i.e., 2) is greater than the first authorization value (i.e., 1), and the first authorization value (i.e., 1) is greater than the zero authorization value (i.e., 0). Additionally, at this time, the value of the zero stage value is equal to the value of the zero authorization value (both are 0), the value of the first stage value is equal to the value of the first authorization value (both are 1), and the value of the second stage value is equal to the value of the second authorization value (both are 2). When the second control circuit 12 executes the control procedure P1, first, the second control circuit 12 reads the authorization value and the development stage board number value (Step S01). Then, the second control circuit 12 compares the value of the authorization value and the value of the development stage board number value (Step S02). When the authorization value is greater than or equal to the development stage board number value, the second control circuit 12 determines whether the development stage board number value is 0 and whether the authorization value is 0 (Step S03). When the development stage board number value is 0 and the authorization value is 0, the second control circuit 12 sets the authorization value to 2 (Step S04). When the authorization value is less than the development stage board number value, the second control circuit 12 further sets the value of the authorization value to be equal to the value of the development stage board number value (Step S07). Next, the second control circuit 12 determines whether the authorization value is 2 or 1 (Step S05). When the authorization value is 2, the second control circuit 12 determines that the data cannot be transmitted from the first input/output circuit 113 to the second input/output circuit 114 (Step S06). When the authorization value is 1, the second control circuit 12 determines whether the development stage board number value is 2 (Step S08). When the development stage board number value is 2, the second control circuit 12 determines that the data cannot be transmitted from the first input/output circuit 113 to the second input/output circuit 114 (Step S06). When the development stage board number value is not 2 (i.e., 0 or 1), the second control circuit 12 determines that the data can be transmitted from the first input/output circuit 113 to the second input/output circuit 114 (Step S09). The relationship between the development stage board number value, the authorization value, and the second control circuit 12's determination of whether the data can be transmitted from the first input/output circuit 113 to the second input/output circuit 114 is shown in Table 1 below. In Table 1, “Yes” indicates that the second control circuit 12 determines that the data can be transmitted from the first input/output circuit 113 to the second input/output circuit 114, while “No” indicates that the second control circuit 12 determines that the data cannot be transmitted from the first input/output circuit 113 to the second input/output circuit 114.

TABLE 1

| | | Authorization Value | | |
|---|---|---|---|---|
| | | Zero Authorization | First Authorization | Second Authorization |
| | | Value | Value | Value |
| Development | Zero Stage Value | No | Yes | No |
| Stage Board | First Stage Value | Yes | Yes | No |
| Number Value | Second Stage Value | No | No | No |

It should be noted that although Table 1 shows scenarios where the authorization value is the zero authorization value, in reality, when the second control circuit 12 determines whether the data can be transmitted from the first input/output circuit 113 to the second input/output circuit 114 according to the authorization value and the development stage board number value, it is not possible for the authorization value to be the zero authorization value. This is because, when the authorization value is the zero authorization value and the development stage board number value is the zero stage value, the authorization value will be set to the second authorization value in Step S04. Additionally, when the authorization value is the zero authorization value and the development stage board number value is the first or the second stage value, the authorization value must be less than the development stage board number value, and the authorization value will be set to the development stage board number value in Step S07. Both Step S04 and Step S07 occur before the point at which the second control circuit 12 determines whether the data can be transmitted from the first input/output circuit 113 to the second input/output circuit 114 (i.e., Step S05). Therefore, at the time the second control circuit 12 determines whether the data can be transmitted from the first input/output circuit 113 to the second input/output circuit 114, it is not possible for the authorization value to be the zero authorization value.

In some embodiments, the first control circuit 11 is further coupled to the second control circuit 12. In some embodiments, before the second control circuit 12 executes the control procedure P1, the initial value of the authorization value is set by the first control circuit 11 and stored in the second storage unit 121. In some embodiments, when the initial value of the authorization value is the first authorization value, it indicates that the first control circuit 11 is still in the development stage, and when the initial value of the authorization value is the second authorization value, it indicates that the development of the first control circuit 11 has been completed. In some embodiments, the developer of the first control circuit 11 can determine whether the user of the server system 1 is allowed to write to the second controller 112 by setting the initial value of the authorization value through the first control circuit 11. When the initial value of the authorization value is the second authorization value, it indicates that the developer of the first control circuit 11 refuses to allow the user of the server system 1 to write to the second controller 112. Conversely, when the initial value of the authorization value is the first authorization value, it means that the developer of the first control circuit 11 allows the user of the server system 1 to write to the second controller 112.

In some embodiments, the circuit board 10 comprises a plurality of resistors. Each of the resistors has a corresponding attribute according to whether one of its ends is electrically connected to a power supply or ground. For example, when one end of the resistor is electrically connected to the power supply, the resistor has a pull-up resistor attribute. Conversely, when one end of the resistor is electrically connected to the ground, the resistor has a pull-down resistor attribute. In some embodiments, the development stage board number value is determined according to the corresponding attribute of each of the resistors. In some embodiments, when the development stage board number value is the first stage value, it indicates that the circuit board 10 is being used for products in the development stage. When the development stage board number value is the second stage value, it indicates that the circuit board 10 is being used for products in the mass production stage.

In some embodiments, the second control circuit 12 further comprises a switch circuit 13. The switch circuit 13 is coupled to the second input/output circuit 114 and the first input/output circuit 113. In some embodiments, the second control circuit 12 is further configured to turn off the switch circuit 13 to disconnect the transmission path from the first input/output circuit 113 to the second input/output circuit 114 (step S10) when the second control circuit 12 determines, according to the authorization value and the development stage board number value, that the data cannot be transmitted from the first input/output circuit 113 to the second input/output circuit 114. Moreover, when the second control circuit 12 determines, according to the authorization value and the development stage board number value, that the data can be transmitted from the first input/output circuit 113 to the second input/output circuit 114, the second control circuit 12 turns on the switch circuit 13 to connect the second input/output circuit 114 and the first input/output circuit 113 (step S11). In some embodiments, the switch circuit 13 may be but not limited to a multiplexer.

In some embodiments, the second input/output circuit 114 is coupled to the first input/output circuit 113 through a receive line (RX Line) and a transmit line (TX Line). In some embodiments, when the second control circuit 12 determines that data cannot be transmitted from the first input/output circuit 113 to the second input/output circuit 114, the second control circuit 12 is further configured to turn off the switch circuit 13 to disconnect the receive line, thereby preventing the data from being written to the second controller 112. At this time, the second controller 112 can only be read. Moreover, when the second control circuit 12 determines, according to the authorization value and the development stage board number value, that the data can be transmitted from the first input/output circuit 113 to the second input/output circuit 114, the second control circuit 12 turns on the switch circuit 13 to connect the receive line, thereby allowing the data to be written to the second controller 112. At this time, the second controller 112 can be both read and written.

In some embodiments, the server system 1 further comprises a firmware system 14. The first control circuit 11 further comprises a third controller 115, a third input/output circuit 116, and a firmware input/output circuit 119. The third input/output circuit 116 is coupled to the third controller 115. The firmware system 14 is coupled to the third controller 115 through the firmware input/output circuit 119. The third controller 115 is configured to transmit a debug log L2 of the firmware system 14 to the third input/output circuit 116. In some embodiments, the firmware system 14 may be but not limited to an operating system (OS) or a basic input/output system (BIOS). The firmware input/output circuit 119 may be but not limited to an LPC (Low Pin Count) input/output circuit or an eSPI (Enhanced Serial Peripheral Interface) input/output circuit. In some embodiments, the firmware system 14 is coupled to the firmware input/output circuit 119 through LPC or eSPI, and the firmware input/output circuit 119 is also coupled to the third controller 115 through LPC or eSPI.

In some embodiments, the server system 1 further comprises a logic circuit 15, and the first control circuit 11 further comprises a fourth controller 117 and a fourth input/output circuit 118. The logic circuit 15 is disposed on the circuit board 10 and is coupled to the fourth controller 117. The fourth input/output circuit 118 is coupled to the fourth controller 117. In some embodiments, the fourth controller 117 is configured to transmit a debug log L3 of the logic circuit 15 to the fourth input/output circuit 118. In some embodiments, the logic circuit 15 may be but not limited to a Field-Programmable Gate Array (FPGA).

In some embodiments, the first controller 111 is coupled to the third controller 115, and the fourth controller 117 is also coupled to the third controller 115. In some embodiments, the first controller 111 and the fourth controller 117 are coupled to the third controller 115 through LPC or eSPI. In some embodiments, the second controller 112 is not connected to the first controller 111, the third controller 115, or the fourth controller 117. In other words, in some embodiments, the second controller 112 operates independently within the first control circuit 11, without communication or connection to other controllers within the first control circuit 11. In some embodiments, the first controller 111, the third controller 115, and the fourth controller 117 support Serial Over LAN (SOL), while the second controller 112 does not support SOL due to its lack of connection to the first controller 111, the third controller 115, and the fourth controller 117. In some embodiments, the first controller 111, the second controller 112, the third controller 115, and the fourth controller 117 support the same communication protocol. In some embodiments, the communication protocol supported by the first controller 111, the second controller 112, the third controller 115, and the fourth controller 117 is Universal Asynchronous Receiver-Transmitter (UART).

In some embodiments, the first control circuit 11 is further coupled to a remote management device 2 through a communication network 16. In some embodiments, since the first controller 111, the third controller 115, and the fourth controller 117 support SOL (Serial Over LAN), the user of the server system 1 can input an output command to the first control circuit 11, causing the first control circuit 11 to transmit one of the debug log L1 of the first control circuit 11, the debug log L2 of the firmware system 14, and the debug log L3 of the logic circuit 15 to the management device 2 according to the output command. In some embodiments, the output command may be but not limited to an OEM (Original Equipment Manufacturer) command.

In some embodiments, the output command comprises channel information. The channel information comprises one of a plurality of channels, each of the channels corresponds to one of the first controller 111, the third controller 115, and the fourth controller 117. In some embodiments, the first control circuit 11 further comprises a first storage unit 110. The first storage unit 110 is configured to store the channel information. The first control circuit 11 is further configured to transmit the debug log corresponding to the channel comprised in the channel information to the management device 2 according to the channel information stored in the first storage unit 110. In some embodiments, when the channel comprised in the channel information corresponds to the first controller 111, the first control circuit 11 transmits the debug log L1 of the first control circuit 11 to the management device 2. When the channel corresponds to the third controller 115, the first control circuit 11 transmits the debug log L2 of the firmware system 14 to the management device 2. When the channel corresponds to the fourth controller 117, the first control circuit 11 transmits the debug log L3 of the logic circuit 15 to the management device 2. In some embodiments, the first storage unit 110 may be volatile storage media, non-volatile storage media, or a combination thereof. Volatile storage media include, for example, Random Access Memory (RAM), such as Static Random Access Memory (SRAM) or Dynamic Random Access Memory (DRAM). Non-volatile storage media include, for example, Read-Only Memory (ROM), such as Programmable Read-Only Memory (PROM), Erasable Programmable Read-Only Memory (EPROM), Electrically Erasable Programmable Read-Only Memory (EEPROM), One-Time Programmable Read-Only Memory (OTPROM), or Flash Memory. The type of the second storage unit 110 is not limited herein.

In some embodiments, when the first control circuit 11 initializes, an initial value of the channel information is set by the first control circuit 11 and stored in the first storage unit 110. In some embodiments, when the output command is received by the first control circuit 11, the first control circuit 11 compares the channel information comprised in the output command with the channel information currently stored in the first storage unit 110. When the channel information comprised in the output command is the same as the channel information currently stored in the first storage unit, the first control circuit 11 directly transmits the corresponding debug log to the management device 2 according to the channel information currently stored in the first storage unit 110. When the channel information comprised in the output command differs from the channel information currently stored in the first storage unit, the first control circuit 11 overwrites the channel information stored in the first storage unit 110 with the channel information comprised in the output command and then transmit the corresponding debug log to the management device 2 according to the overwritten channel information stored in the first storage unit 110.

In some embodiments, the management device 2 further comprises a display device 21. In some embodiments, the first control circuit 11 is further configured to display one of the debug log L1 of the first control circuit 11, the debug log L2 of the firmware system 14, and the debug log L3 of the logic circuit 15 on the display device 21 according to the output command.

To sum up, in some embodiments, since the user of the server system 1 can input the output command to the first control circuit 11 to make the first control circuit 11 display the debug log L1 of the first control circuit 11 on the display device 21 according to the output command, R&D engineers of the first control circuit 11 can directly and immediately view the current error messages of the first control circuit 11 on a remote screen, thereby quickly identifying and solving problems. Moreover, since the second control circuit 12 executes the control procedure P1 according to the development stage board number value and the authorization value to control the transmission of the data from the first input/output circuit 113 to the second input/output circuit 114, the R&D engineers of the first control circuit 11 can set the authorization value and the development stage board number value to make the second controller 112 can only be read during the mass production process of the server system 1. This prevents malicious tampering and damage to the first control circuit 11 during the mass production process, thereby enhancing the security of the server system 1.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A server system, comprising:
a first control circuit, wherein the first control circuit comprises:
a first controller;
a second controller;
a first input/output circuit coupled to the first controller; and
a second input/output circuit coupled to the second controller and the first input/output circuit;
wherein the second controller is configured to transmit a debug log of the first control circuit to the second input/output circuit, and the second input/output circuit is configured to transmit the debug log of the first control circuit to the first input/output circuit; and
a second control circuit coupled between the first input/output circuit and the second input/output circuit, wherein the second control circuit is configured to selectively control data to be transmitted from the first input/output circuit to the second input/output circuit.

2. The server system according to claim 1, further comprising:
a circuit board having a development stage board number value, wherein the first control circuit and the second control circuit are disposed on the circuit board, the second control circuit further comprises a second storage unit, the second storage unit is configured to store an authorization value, and the second control circuit is configured to execute a control procedure according to the development stage board number value and the authorization value to control the data to be transmitted from the first input/output circuit to the second input/output circuit.

3. The server system according to claim 2, wherein the development stage board number value is one of a zero stage value, a first stage value, or a second stage value, the authorization value is one of a zero authorization value, a first authorization value, or a second authorization value, the second stage value is greater than the first stage value and the first stage value is greater than the zero stage value, the second authorization value is greater than the first authorization value and the first authorization value is greater than the zero authorization value, the value of the zero stage value is equal to the value of the zero authorization value, the value of the first stage value is equal to the value of the first authorization value, the value of the second stage value is equal to the value of the second authorization value, and the control procedure comprises:
reading the authorization value and the development stage board number value;
comparing the value of the authorization value and the value of the development stage board number value;
when the authorization value is greater than or equal to the development stage board number value, determining whether the development stage board number value is the zero stage value and whether the authorization value is the zero authorization value;
when the development stage board number value is the zero stage value and the authorization value is the zero authorization value, setting the authorization value to the second authorization value;
determining whether the authorization value is the second authorization value or the first authorization value; and
when the authorization value is the second authorization value, determining that the data cannot be transmitted from the first input/output circuit to the second input/output circuit.

4. The server system according to claim 3, wherein the control procedure further comprises:
when the authorization value is less than the development stage board number value, setting the value of the authorization value to be equal to the value of the development stage board number value.

5. The server system according to claim 4, wherein the control procedure further comprises:
when the authorization value is the first authorization value, determining whether the development stage board number value is the second stage value;
when the development stage board number value is the second stage value, determining that the data cannot be transmitted from the first input/output circuit to the second input/output circuit; and
when the development stage board number value is not the second stage value, determining that the data can be transmitted from the first input/output circuit to the second input/output circuit.

6. The server system according to claim 5, wherein the second control circuit further comprises a switch circuit, the switch circuit is coupled to the second input/output circuit and the first input/output circuit, and the control procedure further comprises:
when determining that the data cannot be transmitted from the first input/output circuit to the second input/output circuit, turning off the switch circuit to disconnect the second input/output circuit and the first input/output circuit; and
when determining that the data can be transmitted from the first input/output circuit to the second input/output circuit, turning on the switch circuit to connect the second input/output circuit and the first input/output circuit.

7. The server system according to claim 6, wherein the second input/output circuit is coupled to the first input/output circuit through a receive line and a transmit line, and the control procedure further comprises:
when determining that the data cannot be transmitted from the first input/output circuit to the second input/output circuit, turning off the switch circuit to disconnect the receive line; and
when determining that the data can be transmitted from the first input/output circuit to the second input/output circuit, turning on the switch circuit to connect the receive line.

8. The server system according to claim 7, further comprising a firmware system, wherein the first control circuit further comprises a third controller, a third input/output circuit, and a firmware input/output circuit, the third input/output circuit is coupled to the third controller, the firmware system is coupled to the third controller through the firmware input/output circuit, and the third controller is configured to transmit a debug log of the firmware system to the third input/output circuit.

9. The server system according to claim 8, further comprising a logic circuit, wherein the logic circuit is disposed on the circuit board, the first control circuit further comprises a fourth controller and a fourth input/output circuit, the fourth input/output circuit is coupled to the fourth controller, the logic circuit is coupled to the fourth controller, and the fourth controller is configured to transmit a debug log of the logic circuit to the fourth input/output circuit.

10. The server system according to claim 9, wherein the first controller is coupled to the third controller, the fourth controller is coupled to the third controller, and the first controller, the third controller, and the fourth controller support SOL (Serial Over LAN).

11. The server system according to claim 10, wherein the first control circuit is further coupled to a management device through a communication network, and the first control circuit is further configured to transmit one of the debug log of the first control circuit, the debug log of the firmware system, and the debug log of the logic circuit to the management device according to an output command.

12. The server system according to claim 11, wherein the first control circuit further comprises a first storage unit, the output command further comprises channel information, the channel information comprises one of a plurality of channels, each of the channels corresponds to one of the first controller, the third controller, and the fourth controller, the first storage unit is configured to store the channel information, and the first control circuit is further configured to transmit one of the debug log of the first control circuit, the debug log of the firmware system, and the debug log of the logic circuit to the management device according to the channel information.

13. The server system according to claim 12, wherein the management device further comprises a display device, and the first control circuit is further configured to display one of the debug log of the first control circuit, the debug log of the firmware system, and the debug log of the logic circuit on the display device according to the output command.

14. The server system according to claim 5, wherein the first control circuit is further coupled to the second control circuit, and before the second control circuit executes the control procedure, an initial value of the authorization value is set by the first control circuit and stored in the second storage unit.

15. The server system according to claim 8, wherein the firmware input/output circuit is a Low Pin Count (LPC) input/output circuit or an Enhanced Serial Peripheral Interface (eSPI) input/output circuit, the firmware system is coupled to the firmware input/output circuit through LPC or eSPI, and the firmware input/output circuit is also coupled to the third controller through LPC or eSPI.

16. The server system according to claim 9, wherein the first controller is coupled to the third controller, the fourth controller is coupled to the third controller, and the second controller is not connected to the first controller, the third controller, or the fourth controller.

17. The server system according to claim 10, wherein the first controller, the second controller, the third controller, and the fourth controller support the same communication protocol.

18. The server system according to claim 17, wherein the communication protocol supported by the first controller, the second controller, the third controller, and the fourth controller is Universal Asynchronous Receiver-Transmitter (UART).

19. The server system according to claim 12, wherein when the first control circuit initializes, an initial value of the channel information is set by the first control circuit and stored in the first storage unit.

20. The server system according to claim 19, wherein when the output command is received by the first control circuit, the first control circuit compares the channel information comprised in the output command with the channel information currently stored in the first storage unit; when the channel information comprised in the output command is the same as the channel information currently stored in the first storage unit, the first control circuit directly transmits the corresponding debug log to the management device according to the channel information currently stored in the first storage unit; when the channel information comprised in the output command differs from the channel information currently stored in the first storage unit, the first control circuit first overwrites the channel information currently stored in the first storage unit with the channel information comprised in the output command, and then transmits the corresponding debug log to the management device according to the overwritten channel information stored in the first storage unit.
